(19) United States
(12) Patent Application Publication
(10) Pub. No.: US 2014/0207522 A1
(43) Pub. Date: Jul. 24, 2014

(54) METHOD AND APPARATUS FOR SURVEYING BRAND PREFERENCE

(71) Applicant: Michael Smith, Toronto (CA)

(72) Inventor: Michael Smith, Toronto (CA)

(21) Appl. No.: 14/087,165

(22) Filed: Nov. 22, 2013

Related U.S. Application Data
(60) Provisional application No. 61/755,635, filed on Jan. 23, 2013.

(51) Int. Cl. G06Q 30/02

(52) U.S. Cl. CPC G06Q 30/0203
USPC 705/7.32

(57) ABSTRACT

The present concept is a method for surveying brand preference which includes the steps of providing a participant with a unique identification data card and code. The participants input personal information into a database through an interactive electronic surface device for administering a product taste challenge, wherein the surface device in communication with the identification card and the database. Additionally there is provided an algorithm which based on information in the database corresponding to the identification card selects a product challenge test and a product challenge test selected by the participant is administered and the results of product challenge results are displayed. Personal information includes personal data and personality data, wherein personality data includes answers to survey questions regarding likes and dislikes of selected foods, beverages and tastes.

This application claims priority from previously filed U.S. provisional patent application No. 61/755,635 under the title METHOD AND APPARATUS FOR SURVEYING BRAND PREFERENCE filed Jan. 23, 2013 by Michael Smith.

### FIELD OF THE INVENTION

The present concept relates to methods for surveying and testing brand preference amongst consumers and more particularly relates to a method and apparatus for surveying brand preference.

### BACKGROUND OF THE INVENTION

The present disclosure relates generally to systems and methods for determining brand preference and more particularly to systems and methods for determining brand preference of consumers using present and historical data.

Consumer preference for a product brand can be expressed as a representation of the percentage of consumers who prefer the brand of interest over brands of similar or competitive products as depicted in sales or market share. Brand preference may not correspond directly with market sales and market share due to factors such as pricing, availability and sales and marketing activities. Consumer preference of a brand may be high however market sales and shares for the brand may be low or otherwise non-corresponding to the brand preference value because for example the brand may not be easily available, or available only in selected locations. In some instances changes in consumer brand preference may correspond with changes in brand sales, market share and market value. Therefore it is desirable to obtain knowledge of consumer preference for a particular brand and determine if possible the underlying factors creating such consumer preference. This information may be useful in determining, analysing and improving advertisement campaigns, marketing strategies and the overall competitiveness of the brand.

### SUMMARY OF THE INVENTION

The present disclosure includes methods for creating an independent competitive product challenge for a consumer and corresponding electronic incentive and social media post. A record of consumer, personal personality and preference data is created and stored and subsequently examined and analysed to trigger a unique competitive product challenge for the consumer.

### BRIEF DESCRIPTION OF THE DRAWING

The present concept will now be described by way of example only with reference to the following drawing in which:

FIG. 1 is a schematic top plan view of portion of interactive electronic surface device.

FIG. 2 is a schematic top plan view of portion of interactive electronic surface device.

FIG. 3 is a schematic top plan view of portion of interactive electronic surface device.

FIG. 4 is a schematic top plan view of portion of interactive electronic surface device.

FIG. 5 is a schematic top plan view of portion of interactive electronic surface device.

FIG. 6 is a schematic top plan view of portion of interactive electronic surface device.

FIGS. 7A and 7B is a flow diagram of an algorithm for determining consumer preference for a number of brands of a product that is executed by the system depicted in this figure.

### DETAILED DESCRIPTION OF THE DRAWINGS AND PREFERRED EMBODIMENTS

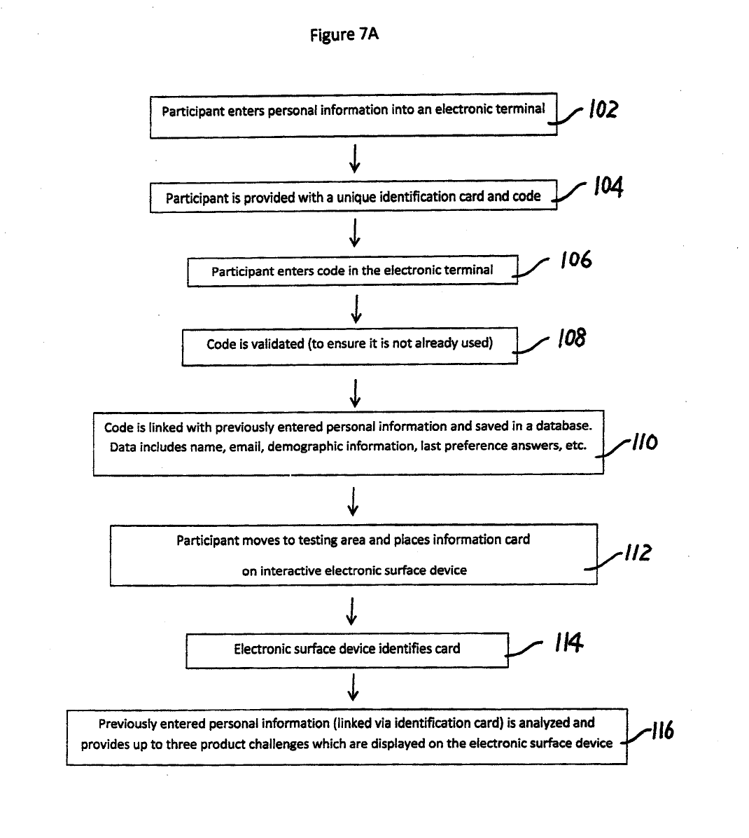

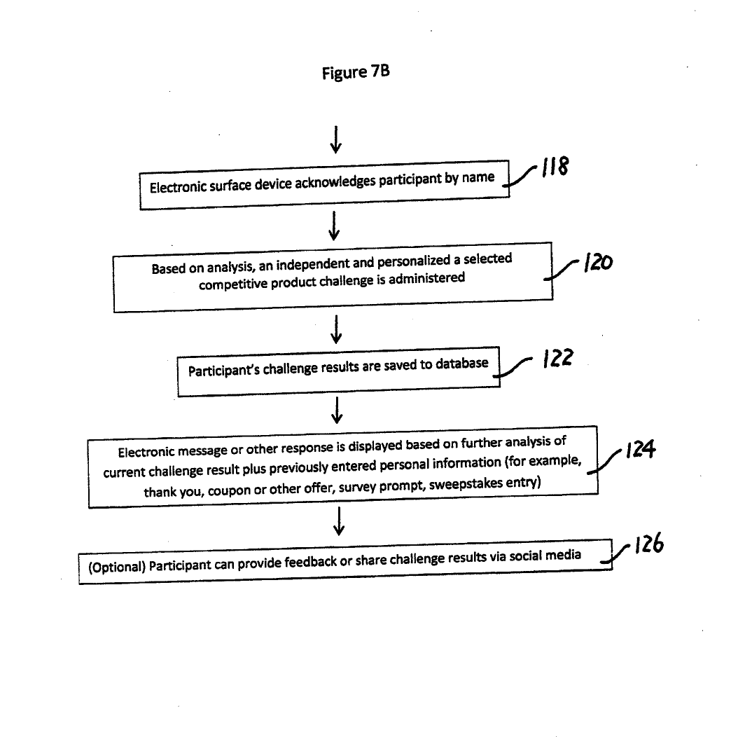

FIGS. 7A and 7B is a flow diagram of the method of carrying out the present concept a method and apparatus for surveying brand preference.

Not shown in the diagrams, however used in the method for surveying brand preferences is either a stationary or mobile kiosk which has an electronic terminal or other smart device attached to it which provides consumers with the ability to enter personal personality and preference information.

A participant is provided with a unique personal identification card which may be a data carrier card or a magnetic data carrier card and enters a unique code into an electronic terminal. The code is validated against the database to ensure it is an authorized and valid number that has not yet been used.

The unique code which is attached to a unique identification card is associated with the participant throughout the process.

Applicant personal, personality, and preference data is transmitted and saved to a database and may include the following information; name, email address, demographic information about the participant, pre-selected personality answers and historical taste and/or other preference answers or data.

The participant at any point after entering their personal information which normally includes, personal, personality and preference data into the electronic terminal may move to a location which includes an interactive electronic surface device. This interactive electronic surface device may include magnetic card readers, touch screen, keyboard input devices, and other electronic input devices such as a mouse. Personal data includes name and address and email address. Personality data includes answers to survey questions regarding likes and dislikes of certain foods, beverages and tastes. Preference data includes historical data of previous challenge test results and taste test results.

The applicant engages the electronic surface device by placing their unique personal identification card on the electronic surface device or passes it through a magnetic card reader. Note that this part of the process may be facilitated by a host although is not essential for a host to be present in order for this process to proceed.

The interactive electronic surface device reads the unique personal identification card and accesses the database which includes consumer personal, personality and preference data.

Based on the applicants data including personal, personality and preference data which is found in the historical database the system analyses and carries out calculations in accordance with an algorithm and then triggers an independent competitive product challenge. The product challenge normally is a product taste test called a product challenge test of two similar or competitive products, however it may also be a taste test of three or more similar or competitive products. The algorithm selects a product challenge test based on personality data or a combination of personality data and preference data. The interactive electronic surface pictorially displays the product challenge tests. A product challenge test selected by the participant is administered. The product challenge results are displayed to the historical database for future use.

The interactive electronic surface device visually or audibly acknowledges the applicant by name or the name of a group of applicants who are taking the challenge at the same time and commences the competitive product challenge. The system analyses the applicant's selections and compares this with their personality and preference information and historical preference information that is in the database. The systems algorithm selects an electronic message to display or send via email or text message to the participant. The electronic message is sent to the participant confirming the test result and providing preselected messages. The message can contain the following information for example the word “thank you” and/or a coupon or other offer can be provided to the participant. It is possible that some reinforcement message about the brand can be sent to the applicant and/or survey information can be provided to the applicant or a further survey may be administered. It is possible also that the system will provide a sweepstake entry for the applicant or other predetermined responses.

The applicants are then provided with a terminal which may be a touch screen keypad or mouse to record immediate feedback and messaging regarding the experience that in accordance with the participant's wishes can be shared and/or posted to social media sites.

Referring now to FIGS. 7A and 7B the method steps are as follows:

In step 1 the participant enters personal information into an electronic terminal as shown as 102.

In step 2 the participant is provided with a unique identification card and code as shown in 104.

In step 3 the participant enters the code into the electronic terminal as shown in 106.

In step 4 the code is validated (to ensure it is not already used) as shown in 108.

In step 5 the code is linked with previously entered personal information and saved in a database. Data included name, email, demographic information, last preference answers, etc., as shown in 110.

In step 6 the participant moves to testing area and places information card on interactive electronic surface device as shown in 112.

In step 7 the electronic surface device identifies card as shown in 114.

In step 8 the previously entered personal information (linked via identification card) is analysed and electronic surface device calculates and selects a product challenge as shown in 116.

In step 9 an electronic surface device acknowledges participant by name as shown in 118.

In step 10 based on analysis, an independent and personalized selected competitive product challenge is administered (for example, Classic Coca Cola vv. Pepsi Cola) as shown in 120.

In step 11 the participant's challenge results are saved to database as shown in 122.

In step 12 an electronic message is displayed based on further analysis of current challenge result plus previously entered personal information (for example, thank you, coupon or other offer, survey prompt, sweepstakes entry) as shown in 124.

In step 13 (optional) the participant can provide feedback or share challenge results via social media as shown in 126.

An example of how the interactive electronic surface device may be used in practice is described as follows:

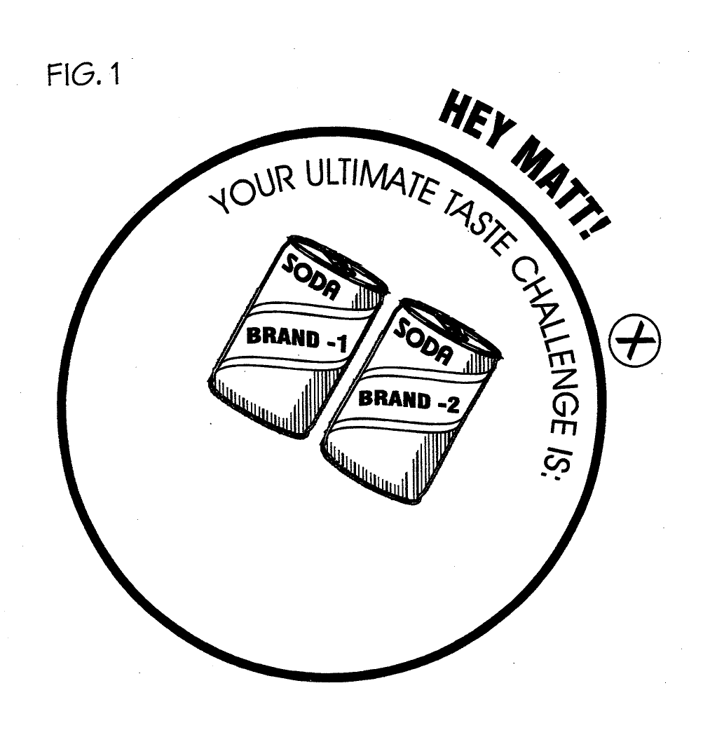

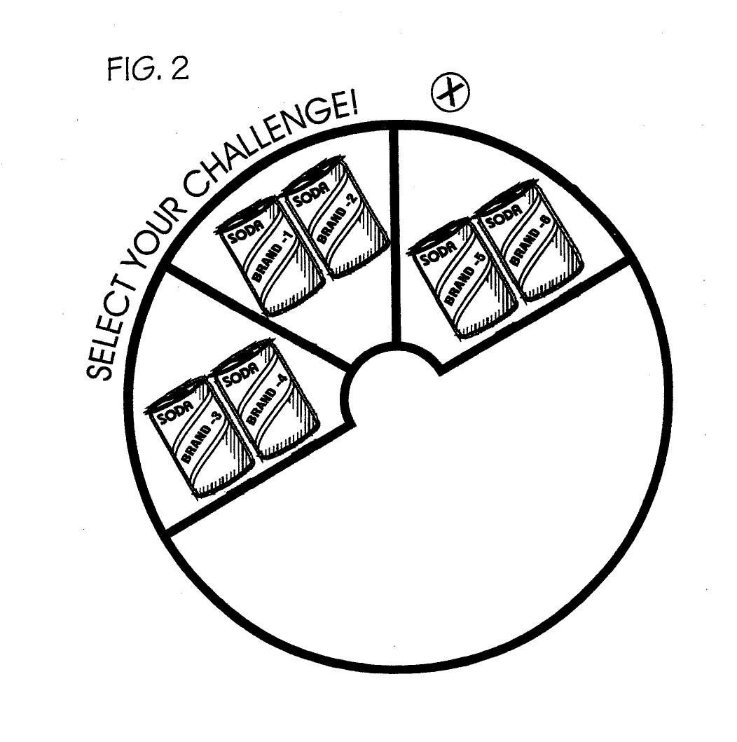

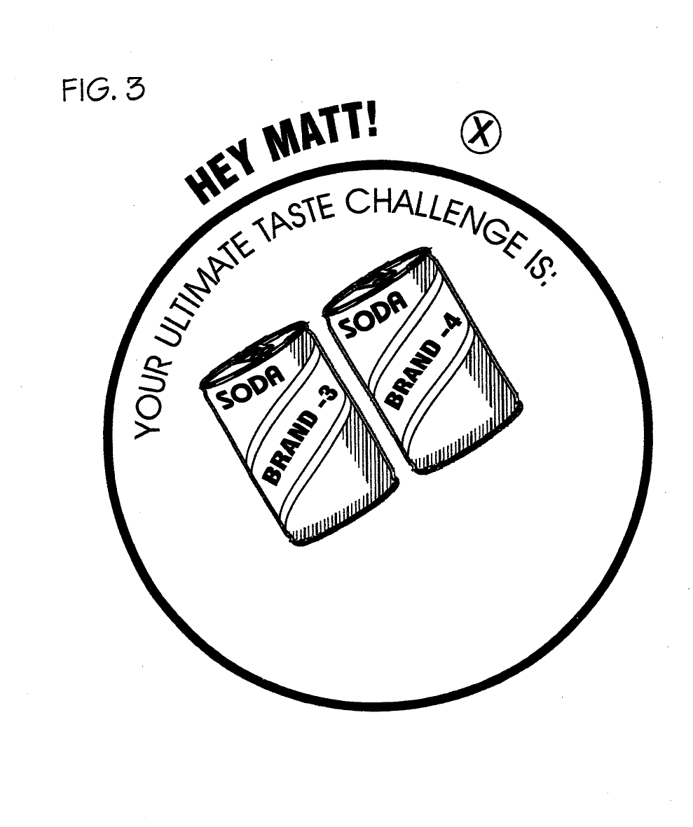

In one example of how the process works, the participant places their card directly in front of them on an interactive electronic surface device which in this case is a touch graphic screen; see FIG. 1. Immediately a circle will appear around the card and above it will read “Select your challenge!” with graphics for three available challenges; see FIG. 2. If a participant would like to move places on the interactive electronic surface device, or view of the graphics is obstructed, simply remove the card and tap the “X” to the top right side and the circle will disappear. The card can then be replaced and restarted. Once a challenge is selected the non-selected graphics will disappear, confirming the selected challenge. Above the circle, it will now read “Hey (participants name)!”; see FIG. 3. If it does not say a name, the challenge will still work and be tracked.

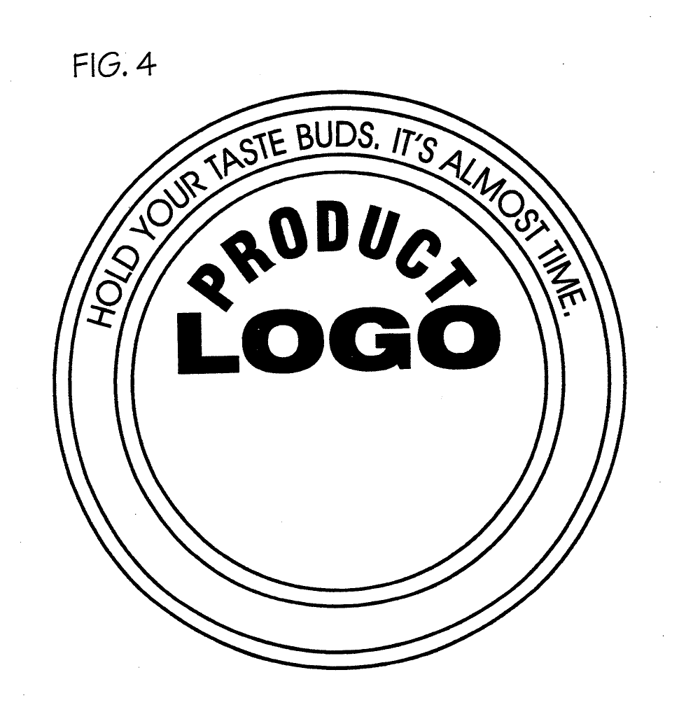

A representative will select sampling cups that are recognizable by the electronic surface and that match the consumer's challenge and place these inside their circle. If the cup is properly recognized by the interactive electronic surface device surface a ring will appear around the base. These will be color-coded to ensure the correct cups are being used for each challenge. The representative then taps the master circle in the centre of the interactive electronic surface device; see FIG. 4, to begin the challenges. The participant will then sample each of the cups, lifting each cup once tasting the contents and returning it inside the circle. Once a cup has been lifted and returned, the bubbles will disappear from around the base.

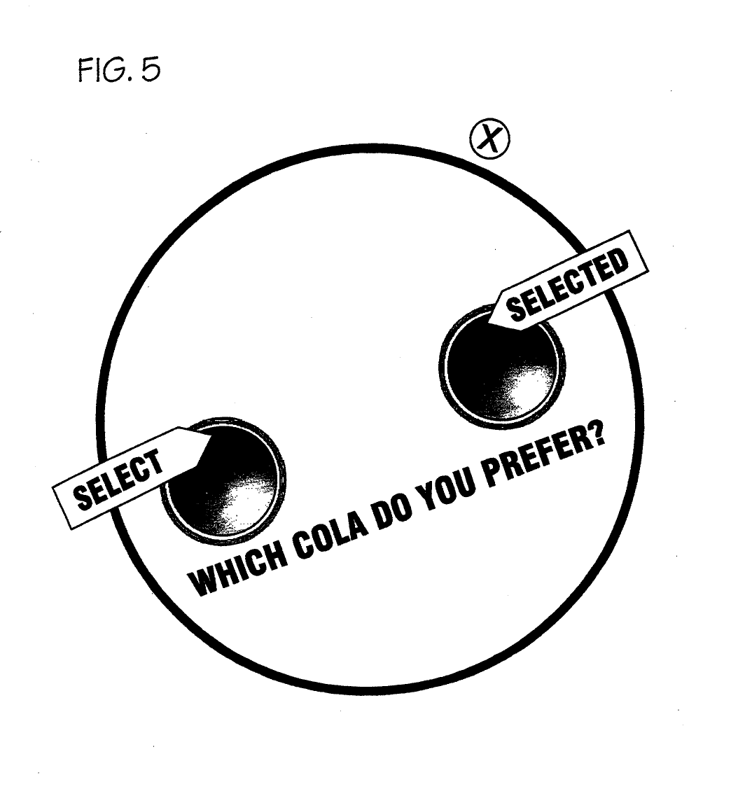

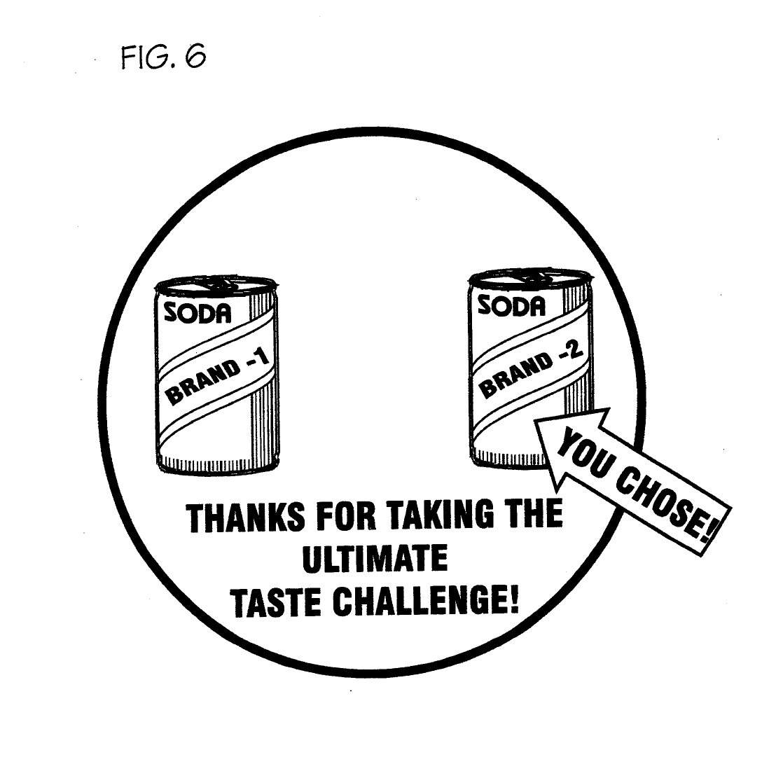

Once both cups have been returned to the interactive electronic surface device following the sampling, tabs will appear next to both cups that reads “Select”. Once selected, the tab will light up and change to “Selected”; see FIG. 5. Once all the participant's at the interactive electronic surface device have selected their favourite sample, the representative then taps the master centre circle to calculate everybody's selections. The participant lifts both cups to reveal which brand they selected as their favourite; see FIG. 6. Once the challenge is complete, the interactive electronic surface device is reset.

It should be apparent to persons skilled in the arts that various modifications and adaptation of this structure described above are possible without departure from the spirit of the invention the scope of which defined in the appended claim.

I claim:

1. A method for surveying brand preference including the steps:
a) providing a participant with a unique identification data card and code;
b) participants input personal information into a database;
c) providing an interactive electronic surface device for administering a product taste challenge, wherein the surface device in communication with the identification card and the database;
d) providing an algorithm which based on information in the database corresponding to the identification card selects a product challenge test;
e) administering a product challenge test selected by the participant;
f) displaying product challenge results.

2. The method for surveying brand preference claimed in claim 1, wherein personal information includes personal data and personality data, wherein personality data includes answers to survey questions regarding likes and dislikes of selected foods, beverages and tastes.

3. The method for surveying brand preference claimed in claim 2, wherein personal information includes personal data, personality data, and preference data wherein preference data includes results of historical product challenge tests.

4. The method for surveying brand preference claimed in claim 2, wherein providing an algorithm which selects a product challenge test based on personality data.

5. The method for surveying brand preference claimed in claim 3, wherein providing an algorithm which selects a product challenge test based on a combination of personality data and preference data.

6. The method for surveying brand preference claimed in claim 1, wherein providing the algorithm which based on information in the database corresponding to the identification card selects up to three potential product challenge tests and displays these product challenge tests on the surface device

7. The method for surveying brand preference claimed in claim 1 and 6, wherein the electronic surface device pictorially displays the product challenge test on the electronic surface device.

8. The method for surveying brand preference claimed in claim 1, wherein an electronic message is sent to the participant.

9. The method for surveying brand preference claimed in claim 1, further includes the step of sending an electronic message to the participant confirming the product challenge test result.

10. The method for surveying brand preference claimed in claim 1, further includes the step of sending a preselected electronic message to the participant consisting of the product challenge test result and a coupon for discounted purchase of one of the tested products.

11. The method for surveying brand preference claimed in claim 1, further includes the step of recording the product challenge test result to the database.
